(19) United States
(12) Patent Application Publication
(10) Pub. No.: US 2020/0125743 A1
(43) Pub. Date: Apr. 23, 2020

(54) DATACENTER SECURITY

(71) Applicant: INTERNATIONAL BUSINESS MACHINES CORPORATION, ARMONK, NY (US)

(72) Inventors: Shashank Gopalakrishna, Bangalore (IN); Heather M. Hinton, Austin, TX (US); Michael J. McGuire, Beaumont Hills (AU); Meenakshisumdaram Venkatasubramaniam, Merrimack, NH (US)

(21) Appl. No.: 16/167,582

(22) Filed: Oct. 23, 2018

(51) Int. Cl. G06F 21/60; G06F 21/62; G06F 17/30; G06F 3/048; G06F 9/54; G07C 9/00

(52) U.S. Cl. CPC G06F 21/604; G06F 21/62; G06F 17/30958; G06Q 10/1091; G06F 9/542; G07C 9/00103; G06F 3/048

(57) ABSTRACT

According to one or more embodiments, a method, a computer program product, and a computer system for datacenter security are provided. The method may accordingly include receiving, by a computer, one or more datacenter security requirements from a user. The computer may determine one or more datacenter security rules corresponding to the received requirements. A plurality of data from one or more sources may be aggregated by the computer, whereby the data may correspond to one or more datacenter parameters. The computer may map the aggregated data to the determined datacenter security rules using a bipartite graph based on a determination that the data falls within a threshold value. One or more gaps in datacenter security coverage may be determined by the computer based on the bipartite graph being non-surjective.

### BACKGROUND

The present invention relates generally to field of computers, and more particularly to datacenters.

A datacenter is a facility used to house computer systems, such as servers and mainframes. These facilities generally include power supplies, HVAC systems, and data communication connections. Because of the sensitive nature of some of the data that may be stored within these facilities, datacenters may also feature heavy security. For example, physical access to the computers may be limited to select personnel for the purposes of maintenance and repair. Moreover, access logs may be kept, which may be supplemented by video surveillance.

### SUMMARY

Embodiments of the present invention disclose a method, system, and computer program product for datacenter security. According to one embodiment, a method for datacenter security is provided. The method may include receiving, by a computer, one or more datacenter security requirements from a user. The computer may determine one or more datacenter security rules corresponding to the received requirements. A plurality of data from one or more sources may be aggregated by the computer, whereby the data may correspond to one or more datacenter parameters. The computer may map the aggregated data to the determined datacenter security rules using a bipartite graph based on a determination that the data falls within a threshold value. One or more gaps in datacenter security coverage may be determined by the computer based on the bipartite graph being non-surjective.

According to another embodiment, a computer system for datacenter security is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving, by a computer, one or more datacenter security requirements from a user. The computer may determine one or more datacenter security rules corresponding to the received requirements. A plurality of data from one or more sources may be aggregated by the computer, whereby the data may correspond to one or more datacenter parameters. The computer may map the aggregated data to the determined datacenter security rules using a bipartite graph based on a determination that the data falls within a threshold value. One or more gaps in datacenter security coverage may be determined by the computer based on the bipartite graph being non-surjective.

According to yet another embodiment, a computer program product for datacenter security is provided. The computer program product may include one or more computer-readable storage devices and program instructions stored on at least one of the one or more tangible storage devices, the program instructions executable by a processor. The program instructions are executable by a processor for performing a method that may accordingly include receiving, by a computer, one or more datacenter security requirements from a user. The computer may determine one or more datacenter security rules corresponding to the received requirements. A plurality of data from one or more sources may be aggregated by the computer, whereby the data may correspond to one or more datacenter parameters. The computer may map the aggregated data to the determined datacenter security rules using a bipartite graph based on a determination that the data falls within a threshold value. One or more gaps in datacenter security coverage may be determined by the computer based on the bipartite graph being non-surjective.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 depicts a block diagram of an exemplary data aggregation system according to at least one embodiment;

FIGS. 3A and 3B depict respective exemplary surjective and non-surjective bipartite graphs, according to at least one embodiment;

FIG. 4 is an operational flowchart illustrating the steps carried out by a program for datacenter security, according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, according to at least one embodiment; and

FIG. 7 is a block diagram of functional layers of the illustrative cloud computing environment of FIG. 6, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to datacenters. The following described exemplary embodiments provide a system, method and program product to, among other things, determine whether datacenter security rules corresponding to user requirements may be implemented. Therefore, embodiments of the present invention have the capacity to improve the field of datacenters by allowing for a computer to aggregate data from a number of sources within the datacenter, and automatically perform actions to resolve security gaps that may exist. Thus, the computer-implement method, computer system, and computer program product disclosed herein may, among other things, be used to save time and money by identifying security gaps within a datacenter and either performing one or more actions to close such gaps or identifying to a system administrator how to solve such gaps.

As previously described, a datacenter is a facility used to house computer systems, such as servers and mainframes. These facilities generally include power supplies, HVAC systems, and data communication connections. Because of the sensitive nature of some of the data that may be stored within these facilities, datacenters may also feature heavy security. For example, physical access to the computers may be limited to select personnel for the purposes of maintenance and repair. Moreover, access logs may be kept, which may be supplemented by video surveillance. It may, therefore, be advantageous to allow for a system to identify gaps in its security or how to close such gaps in order to keep customers' data secure and save on time and labor costs. Accordingly, the invention disclosed herein may improve the field of computing by providing a system, method, and program product to improve datacenter security.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

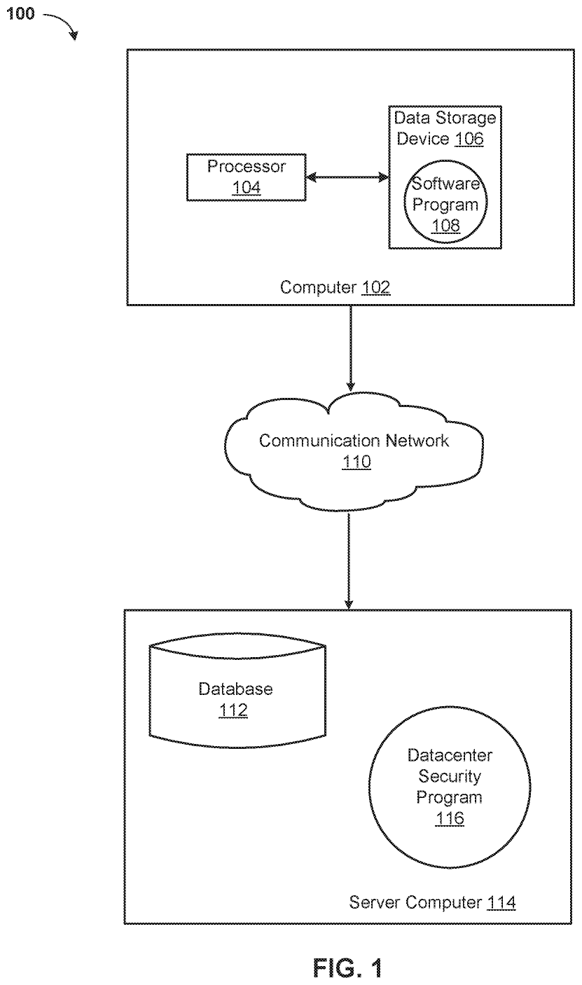

Referring now to FIG. 1, a functional block diagram illustrating a datacenter security system 100 for datacenter security is shown. It should be appreciated that FIG. 1 provides only an illustration of one implementation and does not imply any limitations with regard to the environments in which different embodiments may be implemented. Many modifications to the depicted environments may be made based on design and implementation requirements.

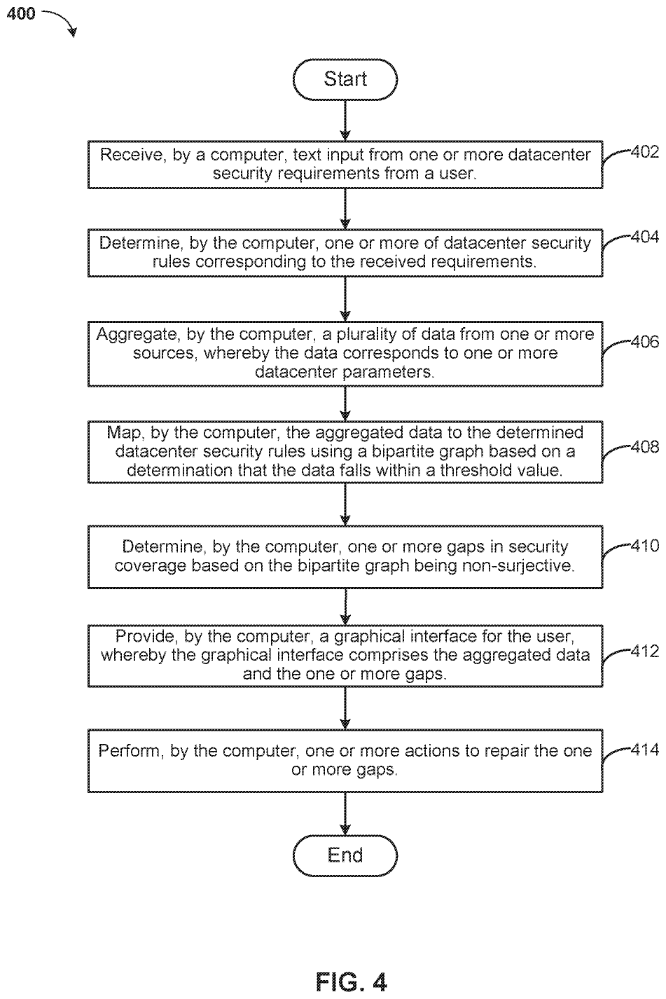

The datacenter security system 100 may include a computer 102 and a server computer 114. The computer 102 may communicate with the server computer 114 via a communication network 110. The computer 102 may include a software program 108 that is stored on a data storage device 106 and is enabled to interface with a user and communicate with the server computer 114. As will be discussed below with reference to FIG. 4 the computer 102 may include internal components 800A and external components 900A, respectively, and the server computer 114 may include internal components 800B and external components 900B, respectively. The computer 102 may be, for example, a mobile device, a telephone, a personal digital assistant, a netbook, a laptop computer, a tablet computer, a desktop computer, or any type of computing devices capable of running a program, accessing a network, and accessing a database.

The server computer 114 may also operate in a cloud computing service model, such as Software as a Service (SaaS), Platform as a Service (PaaS), or Infrastructure as a Service (IaaS), as discussed below. The server computer 114 may also be located in a cloud computing deployment model, such as a private cloud, community cloud, public cloud, or hybrid cloud. The server computer 114, which may be used for aggregating multiple documents from among a corpus of documents into a single document based on required and available content, is enabled to run a Datacenter Security Program 116 that may interact with a database 112. The Collaborative Documentation Program method is explained in more detail below with respect to FIG. 4. In one embodiment, the computer 102 may operate as an input device including a user interface while the Datacenter Security Program 116 may run primarily on server computer 114. In an alternative embodiment, the Datacenter Security Program 116 may run primarily on one or more computers 102 while the server computer 114 may be used for processing and storage of data used by the Datacenter Security Program 116. It should be noted that the Datacenter Security Program 116 may be a standalone program or may be integrated into a larger collaborative documentation program.

It should be noted, however, that processing for the Datacenter Security Program 116 may, in some instances be shared amongst the computers 102 and the server computers 114 in any ratio. In another embodiment, the Datacenter Security Program 116 may operate on more than one computer, server computer, or some combination of computers and server computers, for example, a plurality of computers 102 communicating across the communication network 110 with a single server computer 114. In another embodiment, for example, the Datacenter Security Program 116 may operate on a plurality of server computers 114 communicating across the communication network 110 with a plurality of client computers. Alternatively, the Datacenter Security Program 116 may operate on a network server communicating across the network with a server and a plurality of client computers.

The communication network 110 may include wired connections, wireless connections, fiber optic connections, or some combination thereof. In general, the communication network 110 can be any combination of connections and protocols that will support communications between the computer 102 and the server computer 114. The communication network 110 may include various types of networks, such as, for example, a local area network (LAN), a wide area network (WAN) such as the Internet, a telecommunication network, a wireless network, a public switched network and/or a satellite network.

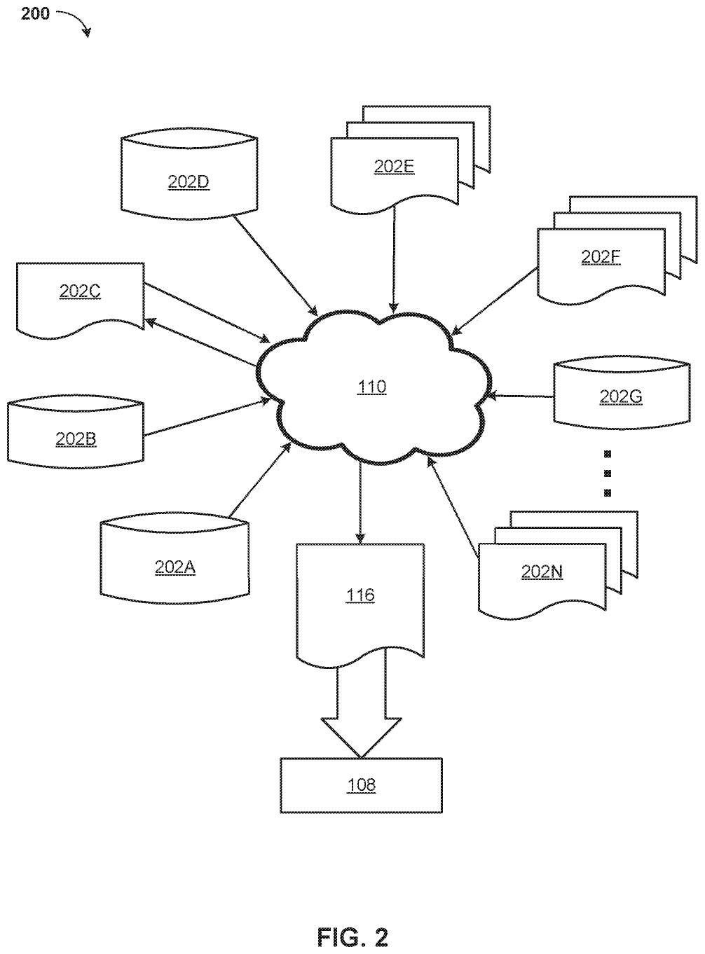

Referring to FIG. 2, a block diagram of exemplary data aggregation system is shown. The system may include a communications network 110 (FIG. 1), the Datacenter Security Program 116 (FIG. 1), the software program 108 (FIG. 1), and one or more data sources 202A-N. The data sources 202A-N may include, among other things, reports created by one or more datacenter devices, sensors within the datacenter, reports corresponding to one or more scheduled tasks, inspection reports, written and electronic reports, visitor log books, visitor approval forms, badge access reports, video feeds of the datacenter, and system and service management data. The Datacenter Security Program 116 may accordingly receive data from the one or more data sources 202A-N, aggregate the received data, and cross-check the data for discrepancies and gaps that may exist within the data. The Datacenter Security Program 116 may share these results with a user via the software program 108.

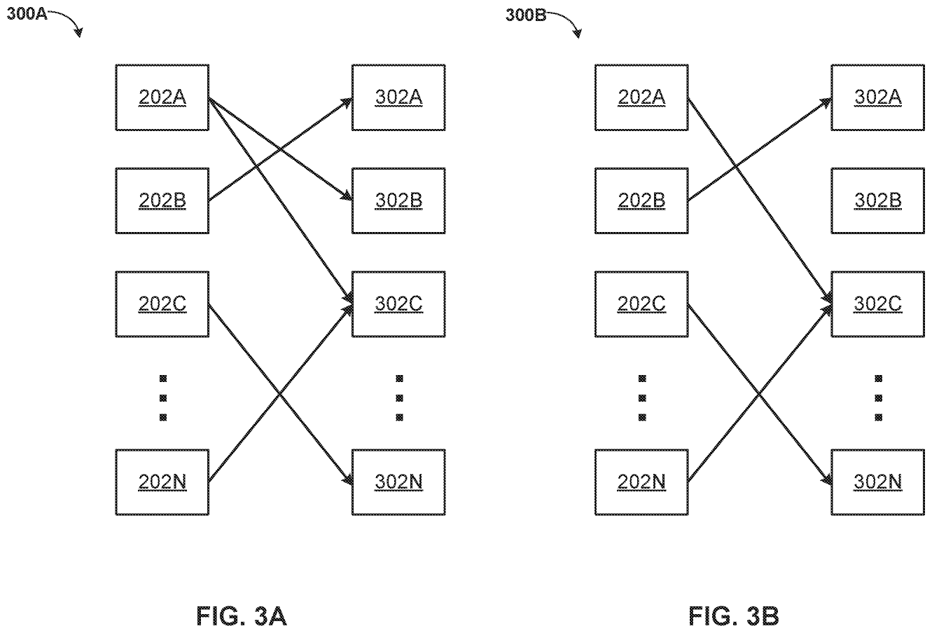

Referring now to FIG. 3A, an exemplary surjective bipartite graph 300A illustrating a mapping of one or more data sources to one or more datacenter security rules is depicted. Each of the datacenter security rules 302A-N may be mapped to by one or more data sources 202A-N (FIG. 2). It may be appreciated that the bipartite graph 300A may contain any number of data sources and datacenter security rules.

Referring now to FIG. 3B, an exemplary non-surjective bipartite graph 300B illustrating a mapping of one or more data sources to one or more datacenter security rules is depicted. There may exist at least one datacenter security rule from among the datacenter security rules 304A-N to which none of the data sources 202A-N (FIG. 2) are mapped (e.g., 304B). According to one embodiment, this may occur because a data source from among the data sources 202A-N corresponding to a given datacenter security rule from among the datacenter security rules 304A-N may not exist. According to an alternative embodiment, this may occur because the one or more data sources from among the data sources 202A-N may be providing incorrect data or data outside a threshold parameter to the Datacenter Center Security Program 116 (FIG. 1). The datacenter security program may, therefore, not map the data source to the datacenter security rule. As was discussed above with respect to the bipartite graph 300A (FIG. 3A), the bipartite graph 300B may contain any number of data sources and datacenter security rules.

Referring now to FIG. 4, an operational flowchart 400 illustrating the steps carried out by a program for datacenter security is depicted. FIG. 4 may be described with the aid of FIGS. 1, 2, and 3B. As previously described, the Datacenter Security Program 116 (FIG. 1) may be used to increase datacenter security.

At 402, one or more datacenter security requirements are received from a user by a computer. The datacenter security requirements may be received in substantially any form, such as text input, voice input, and natural language format. For example, a user may enter hundreds, or even thousands, of rules to govern the security of their data within the datacenter. The text inputs may be in the form of natural language, and the system may interpret the text inputs to determine which rules for datacenter security must be followed. In operation, a user may enter one or more requirements using the software program 108 (FIG. 1) on the computer 102 (FIG. 1) which may be transmitted to the Datacenter Security Program 116 (FIG. 1) on the server computer 114 (FIG. 1) via the communications network 110 (FIG. 1). The received requirements may be stored within the database 112 (FIG. 1).

At 404, one or more datacenter security rules corresponding to the received requirements are determined by the computer. The datacenter security rules may correspond to industry-standard rules and policy frameworks such as NIST 800-73 or ISO27001. In operation, the Datacenter Security Program 116 (FIG. 1) may retrieve the security rules from the database 112 (FIG. 1). In an alternate embodiment, the Datacenter Security Program 116 may retrieve the rules from the Internet via the communications network 110 (FIG. 1). The Datacenter Security Program 116 may determine one or more rules that correspond to the received requirements in response to a conversion of the received requirements to a machine-parsable form.

At 406, a plurality of data from one or more sources is aggregated by the computer, whereby the data corresponds to one or more datacenter parameters. As discussed above, these data sources may include, among other things reports created by one or more datacenter devices, sensors within the datacenter, reports corresponding to one or more scheduled tasks, inspection reports, written and electronic reports, visitor log books, visitor approval forms, badge access reports, video feeds of the datacenter, and system and service management. For example, the device reports may include statuses regarding primary and redundant power supplies and systems, climate control, and fuel levels in one or more generators. The scheduled tasks may include repairs, maintenance, and restocking within the datacenter. The data aggregation may include processing to match events or items discovered from those data sources. Thus, the data that may be aggregated by the computer may include, among other things, names and/or recordings of visitors and contractors to the data center, climate conditions within the datacenter, statuses of devices within the datacenter, past and scheduled maintenance of the devices within the datacenter, and the like. In operation, the Datacenter Security Program 116 (FIG. 1) may receive data from one or more data sources 202A-N (FIG. 2) via the communications network 110 (FIG. 1). Each of these data sources 202A-N may correspond to one or more rules retrieved from the database 112 (FIG. 1) on the server computer 114 (FIG. 1).

At 408, the aggregated data is mapped by the computer to the determined datacenter security rules using a bipartite graph based on a determination that the data falls within a threshold value. As discussed above, the rules may be industry-standard rules, such as those covered by NIST 800-73 or ISO27001. A plurality of rules governing the operation of the datacenter may have been identified. The system may, therefore, identify one or more data sources corresponding to each of the rules, such that compliance with each of the rules is verified. In operation, the Datacenter Security Program 116 (FIG. 1) may compare the data received from the data sources 202A-N (FIG. 2) over the communications network 110 (FIG. 1) to the rules identified from the database 112 (FIG. 1) to determine which data sources from among the data sources 202A-N correspond to each of the datacenter rules. The results of this comparison may be recorded by mapping the data received from the data sources 202A-N to the one or more datacenter security rules 304A-N (FIG. 3B) using a bipartite graph 300B (FIG. 3B).

At 410, one or more gaps in security coverage is determined by the computer based on the bipartite graph being non-surjective. If the computer determines that no data exists for a given rule, the computer may therefore determine that there may exist a gap in datacenter security. For example, badge access record and video feed information may be matched to visitor entry books in order to determine that an entry was missing from the entry book and which may indicate noncompliance with a given rule. In operation, the Datacenter Security Program 116 (FIG. 1) may determine that there exists a rule within the database 112 (FIG. 1) for which there are no data sources from among the data sources 202A-N (FIG. 2) that may be used to verify the datacenter is in compliance with the industry-standard rules by determining that the bipartite graph 300B (FIG. 3B) is non-surjective. Alternatively, the Datacenter Security Program 116 may determine that a data source from among the data sources 202A-N that may be used to verify compliance with the rule within the database 112 may have malfunctioned and needs repair. Accordingly, the Datacenter Security Program 116 may determine that action may need to be performed to repair or upgrade the datacenter to ensure security and compliance with security rules. According to one or more various embodiments, the computer may be configured to proceed to one or more of 412, 414, and 416.

At 412, the computer provides a graphical interface for the user, whereby the interface comprises the aggregated data and the one or more security gaps. The user interface may contain a dashboard for a real-time view of compliance, as well as pre-defined reports that may provide an in-depth view of individual areas. The user interface may also contain a query tool to allow for generation of custom reports for more fine-grained evidence information. The user interface may show only single tenant data and can thus be exposed to all of the data center's customers. These customers may be limited to the dashboard and a subset of predefined reports in order to provide access control. The access control requirement may be configured by the datacenter. The user interface may provide alerts to the data center compliance team in the event that the system perceives that the compliance state may be or has been degraded based on received input. In an alternative embodiment, the computer may notify a system administrator of the one or more determined security gaps. The notification may take place with or without intervention already having taken place by the computer and may include steps that the system administrator may need to perform to correct the gaps in security. In operation, the Datacenter Security Program 116 (FIG. 1) may communicate with the software program 108 (FIG. 1) via the communications network 110 to provide a user interface to the datacenter. The software program 108 may display one or more reports and a live video stream of the datacenter.

At 414, the computer performs one or more actions to repair the one or more security gaps. According to one or more embodiments, these actions may include raising an alarm, starting up one or more datacenter systems, shutting down one or more datacenter systems, blocking access to one or more datacenter systems, blocking access to the datacenter, and enabling access to the datacenter to one or more technicians. The alerts, for example, may be raised to a local facility team for investigation or to one or more clients whose data may be hosted within the datacenter to take further action, such as notifying customers of the potential for data breach or deleting sensitive data from the datacenter. According to an alternate embodiment, the computer may cause the system administrator to repair the one or more gaps. The computer may enable the system administrator to manually fix any gaps in security coverage by enabling the system administrator to enter the datacenter to make repairs, perform maintenance, or carry out any steps necessary for securing the datacenter based on the determined security gaps. In operation, the Datacenter Security Program 116 (FIG. 1) may secure the datacenter via the communications network 110 (FIG. 1) in response to a gap in protection being determined. The Datacenter Security Program 116 may block physical access to the datacenter except by an authorized technician.

It may be appreciated that FIG. 4 provides only an illustration of one implementation and does not imply any limitations with regard to how different embodiments may be implemented. Many modifications to the depicted environments may be made based on design and implementation requirements.

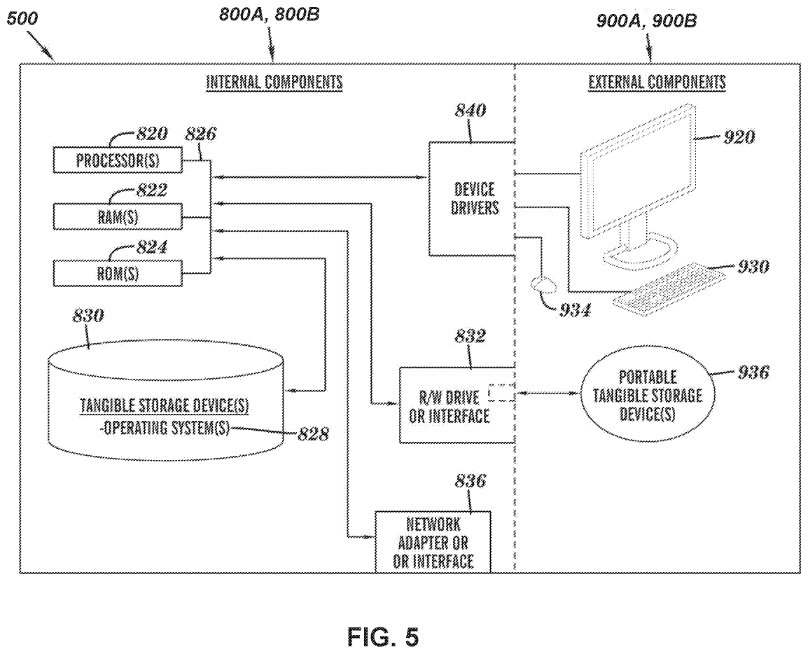

FIG. 5 is a block diagram 500 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Computer 102 (FIG. 1) and server computer 114 (FIG. 1) may include respective sets of internal components 800A,B and external components 900A,B illustrated in FIG. 5. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the Software Program 108 (FIG. 1) and the Datacenter Security Program 116 (FIG. 1) on server computer 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800A,B also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Datacenter Security Program 116 (FIG. 1) can be stored on one or more of the respective portable computer-readable tangible storage devices 936, read via the respective R/W drive or interface 832 and loaded into the respective hard drive 830.

Each set of internal components 800A,B also includes network adapters or interfaces 836 such as a TCP/IP adapter cards; wireless Wi-Fi interface cards; or 3G, 4G, or 5G wireless interface cards or other wired or wireless communication links. The Software Program 108 (FIG. 1) and the Datacenter Security Program 116 (FIG. 1) on the server computer 114 (FIG. 1) can be downloaded to the computer 102 (FIG. 1) and server computer 114 from an external computer via a network (for example, the Internet, a local area network or other, wide area network) and respective network adapters or interfaces 836. From the network adapters or interfaces 836, the Software Program 108 and the Datacenter Security Program 116 on the server computer 114 are loaded into the respective hard drive 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

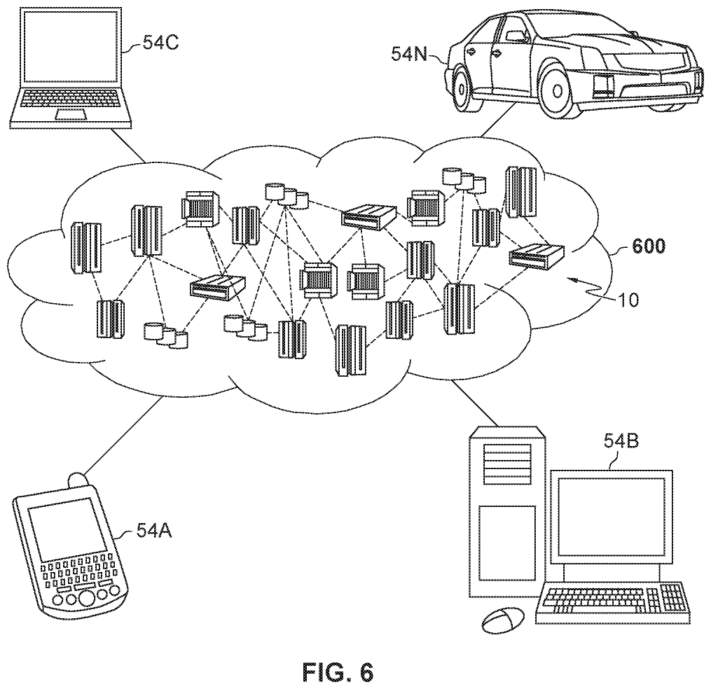

Referring to FIG. 6, illustrative cloud computing environment 600 is depicted. As shown, cloud computing environment 600 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 54A-N shown in FIG. 6 are intended to be illustrative only and that cloud computing nodes 10 and cloud computing environment 600 can communicate with any type of computerized device over any type of network and/or network addressable connection (e.g., using a web browser).

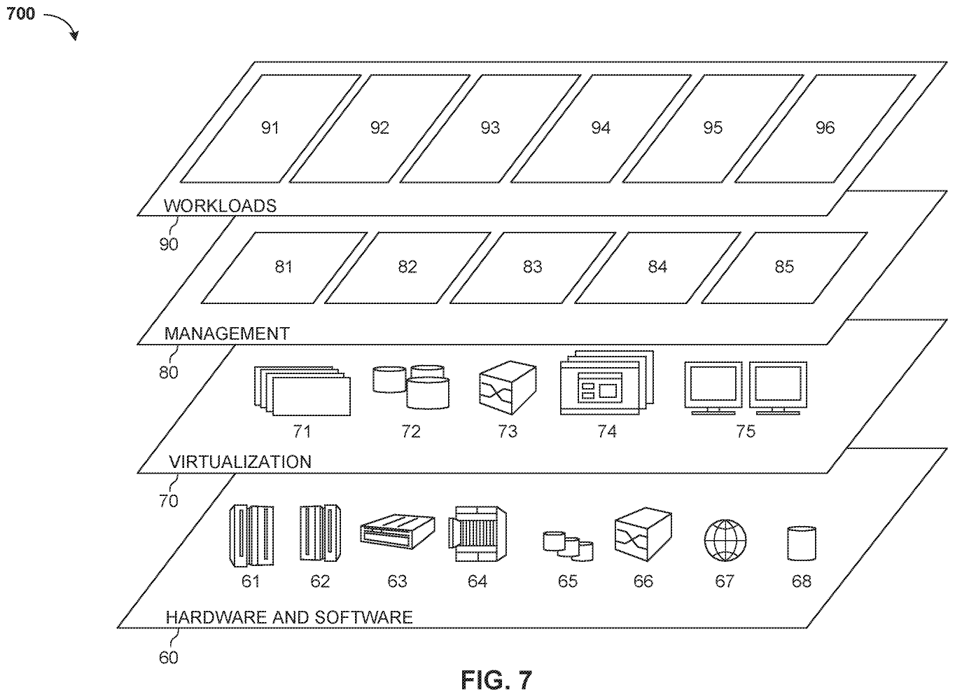

Referring to FIG. 7, a set of functional abstraction layers 700 provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and datacenter security 96. Datacenter security may aggregate data from multiple sources to determine whether datacenter security rules corresponding to user requirements may be implemented and to determine gaps that may exist in datacenter security coverage.

The present invention may be a system, a method, and/or a computer program product at any possible technical detail level of integration. The computer program product may include a computer-readable non-transitory storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of datacenter security, comprising:
receiving, by a computer, one or more datacenter security requirements from a user;
determining, by the computer, one or more datacenter security rules corresponding to the received requirements;
aggregating, by the computer, a plurality of data from one or more sources, wherein the data corresponds to one or more datacenter parameters;
mapping, by the computer, the aggregated data to the determined datacenter security rules using a bipartite graph based on a determination that the data falls within a threshold value;
determining, by the computer, one or more gaps in security coverage based on the bipartite graph being non-surjective.

2. The method of claim 1, wherein the one or more sources are selected from a group consisting of:
a report created by one or more datacenter devices;
a sensor within the datacenter;
a report corresponding to one or more scheduled tasks;
an inspection report;
a written report;
an electronic report;
a visitor log book;
a visitor approval form;
a badge access report;
a video feed of the datacenter; and
system and service management data.

3. The method of claim 1, further comprising:
providing, by the computer, a graphical interface for the user, wherein the graphical interface comprises the aggregated data and the one or more gaps.

4. The method of claim 1, further comprising:
notifying, by the computer, a system administrator of the one or more determined gaps; and
causing, by the computer, the system administrator to repair the one or more gaps.

5. The method of claim 1, further comprising:
performing, by the computer, one or more actions to repair the one or more gaps.

6. The method of claim 5, wherein the one or more actions are selected from a group consisting of:
raising an alarm;
starting up one or more datacenter systems;
shutting down one or more datacenter systems;
blocking access to one or more datacenter systems;
blocking access to the datacenter; and
enabling access to the datacenter to one or more technicians.

7. The method of claim 1, wherein the datacenter security rules correspond to industry-standard rules.

8. A computer program product for datacenter security r, the computer program product comprising:
one or more computer-readable storage media and program instructions stored on the one or more computer readable storage media, the program instructions comprising:
program instructions to receive, by a computer, one or more datacenter security requirements from a user;
program instructions to determine, by the computer, one or more datacenter security rules corresponding to the received requirements;
program instructions to aggregate, by the computer, a plurality of data from one or more sources, wherein the data corresponds to one or more datacenter parameters;
program instructions to map, by the computer, the aggregated data to the determined datacenter security rules using a bipartite graph based on a determination that the data falls within a threshold value;
program instructions to determine, by the computer, one or more gaps in security coverage based on the bipartite graph being non-surjective.

9. The computer program product of claim 8, wherein the one or more sources are selected from a group consisting of:
a report created by one or more datacenter devices;
a sensor within the datacenter;
a report corresponding to one or more scheduled tasks;
an inspection report;
a written report;
an electronic report;
a visitor log book;
a visitor approval form;
a badge access report;
a video feed of the datacenter; and
system and service management data.

10. The computer program product of claim 8, further comprising:
program instructions to provide, by the computer, a graphical interface for the user, wherein the graphical interface comprises the aggregated data and the one or more gaps.

11. The computer program product of claim 8, further comprising:
program instructions to notify, by the computer, a system administrator of the one or more determined gaps; and
program instructions to cause, by the computer, the system administrator to repair the one or more gaps.

12. The computer program product of claim 8, further comprising:
program instructions to perform, by the computer, one or more actions to repair the one or more gaps.

13. The computer program product of claim 12, wherein the one or more actions are selected from a group consisting of:
raising an alarm;
starting up one or more datacenter systems;
shutting down one or more datacenter systems;
blocking access to one or more datacenter systems;
blocking access to the datacenter; and
enabling access to the datacenter to one or more technicians.

14. The computer program product of claim 8, wherein the datacenter security rules correspond to industry-standard rules.

15. A computer system for datacenter security, the computer system comprising:
one or more computer processors, one or more computer-readable storage media, and program instructions stored on the one or more computer-readable storage media for execution by at least one of the one or more computer processors capable of performing a method, the method comprising:
receiving, by a computer, one or more datacenter security requirements from a user;
determining, by the computer, one or more datacenter security rules corresponding to the received requirements;
aggregating, by the computer, a plurality of data from one or more sources, wherein the data corresponds to one or more datacenter parameters;
mapping, by the computer, the aggregated data to the determined datacenter security rules using a bipartite graph based on a determination that the data falls within a threshold value;
determining, by the computer, one or more gaps in security coverage based on the bipartite graph being non-surjective.

16. The computer system of claim 15, wherein the one or more sources are selected from a group consisting of:
a report created by one or more datacenter devices;
a sensor within the datacenter;
a report corresponding to one or more scheduled tasks;
an inspection report;
a written report;
an electronic report;
a visitor log book;
a visitor approval form;
a badge access report;
a video feed of the datacenter; and
system and service management data.

17. The computer system of claim 15, further comprising:
providing, by the computer, a graphical interface for the user, wherein the graphical interface comprises the aggregated data and the one or more gaps.

18. The computer system of claim 15, further comprising:
notifying, by the computer, a system administrator of the one or more determined gaps; and
causing, by the computer, the system administrator to repair the one or more gaps.

19. The computer system of claim 15, further comprising:
performing, by the computer, one or more actions to repair the one or more gaps.

20. The computer system of claim 19, wherein the one or more actions are selected from a group consisting of:
raising an alarm;
starting up one or more datacenter systems;
shutting down one or more datacenter systems;
blocking access to one or more datacenter systems;
blocking access to the datacenter; and
enabling access to the datacenter to one or more technicians.
